(19) United States
(12) Patent Application Publication
(10) Pub. No.: US 2002/0093978 A1
(43) Pub. Date: Jul. 18, 2002

(54) Synchronous protocol encoding and decoding method

(75) Inventors: Giridharan Anantharaman, Chennai (IN); Bhaskar Harita, Bangalore (IN)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/760,425

(22) Filed: Jan. 12, 2001

(51) Int. Cl. H04J 3/16

(52) U.S. Cl. 370/466; 370/505

(57) ABSTRACT

A method to encode and decode frames of data used in the synchronous HDLC protocol operates on blocks of data, as opposed to bit-by-bit. A first reference (“lookup”) table is provided for zero insertion during the HDLC encoding process and a second reference table is provided for flag or abort signal detection and zero deletion during the HDLC decoding process.

### BACKGROUND OF THE INVENTION

1. Field of the Invention

The present invention relates to synchronous protocols and more particularly to methods and data structures for encoding and decoding streams of synchronous protocol data.

2. Description of Related Art

With growing data transmission and reception rates, there is a growing need for synchronous protocols like High Level Data Link Control (HDLC) to process data streams at an increasingly faster rate. To achieve faster rates of data processing, the HDLC data must be processed a byte or word at a time, rather than using conventional methods of processing data on a bit by bit basis.

Synchronous protocols are widely used in data transmission and reception. Protocols such as High-Level Data Link Control (“HDLC”) and Synchronous Data Link Control (“SDLC”) are used to synchronize such transmission and reception to transmit data accurately. Typically, in a protocol such as HDLC, a particular signal known as a “flag”, having a predetermined binary sequence such as 01111110 (7Eh) is transmitted at both the beginning and the end of a data bit stream to delimit the data. Other signals may also be transmitted with such protocols, such as an “abort” signal, which may have a predetermined binary sequence such as 01111111 (7Fh).

Synchronous protocols such as HDLC and SDLC should include a methodology to distinguish such predetermined or otherwise specific signals from possible combinations or sequences of data. For example, there is a probability that a particular data stream could have a 7Eh sequence, which could create confusion with a flag sequence. HDLC uses a method known as bit stuffing to avoid such confusion between data and flags. In the data stream, a zero bit is inserted after five consecutive one bits (“zero insertion”) in the transmission of the data stream, to prevent six or seven consecutive one bits from appearing in the data. Upon reception of the data stream, the HDLC protocol unstuffs the data stream by deleting the inserted zero (“zero deletion”) to restore the data to its original form.

The HDLC zero insertion/deletion process is usually performed in hardware with a serial protocol integrated circuit (IC) that has shift registers, counters and other circuits. Discrete IC implementations are also available. Software solutions typically contain processor microcode or instructions that simulate the same basic functions of the shift registers, counters, etc. of the serial hardware solutions. The various hardware solutions are expensive and require additional board area to accommodate the hardware. Further, the hardware solutions may not be feasible with weight, space and volume limitations of many applications, such as modems for hand-held devices.

The various conventional software solutions, by simulating the basic hardware functions and operating on the data one bit at a time, also have shortcomings. Typical software implementations require a processor with significant processing bandwidth to execute zero insertion/deletion methodologies at the high data rates common today. Such processing architectures having such significant bandwidth requirements may not be available. Software implementations that use the reference (“look up”) table technique consume a large portion of a processor's computing power because the structure of the lookup table is such that even after a look up is performed, more computations must be done to extract the required bit stuffed or bit unstuffed pattern. Major issues that need to be addressed are how to efficiently keep track of the number of consecutive ones encountered especially when they span across octet or word boundaries, and how to perform flag/abort sequence detection in a sequence of data bytes without any extra overhead.

U.S. Pat. Nos. 5,675,617 and 5,671,223 assigned to Motorola Inc. or Schaumburg, Illinois, the assignee of the present application, and hereby incorporated by reference, are directed to methods of encoding and decoding protocol compliant data streams. The former discloses a reference table approach, while the latter uses a shift register approach. While both of these patents provide improvements in data processing, further improvement is believed possible.

### SUMMARY OF THE INVENTION

The present invention provides a method of encoding and decoding frames of data used in a synchronous protocol, such as HDLC. The invention operates on blocks of data, as opposed to serial bits and uses a first reference (“lookup”) table for zero insertion during the data encoding process and a second reference table for flag or abort signal detection and zero deletion during the data decoding process. Since all of the encode procedure requirements are integrated into the first reference table, only a single read operation is required for bit stuffing. On the decode side, since all of the decode procedure requirements are integrated into the second reference table, decoding is performed on bytes of data with a single read of the second table. The invention also maintains proper data alignment following zero insertions or deletions.

In a first embodiment, the present invention provides a method of encoding a data stream, including the steps of reading a predetermined amount of data from the data stream and identifying an entry of an encode data table using the predetermined amount of read data and a current state value. The encode data table has a plurality of table entries, each including a state field containing state information and a data field containing a predetermined data pattern. Then, the identified table entry is read and the state information the predetermined data pattern are extracted from the read table entry. Finally, the predetermined data pattern read from the table entry is output as encoded data.

In accordance with the first embodiment, a data structure for encoding predetermined amounts of data read from a data stream to HDLC protocol compliant data is provided. The data structure includes a data field containing HDLC encoded data corresponding to the predetermined amount of data read from the data stream, a state field defined by a current count of consecutive bits having a value of one read from the data stream, and a stuffed bits field that is defined by the number of bits added to the predetermined amount of data to form the HDLC encoded data in the data field.

In a second embodiment, the present invention provides a method of decoding an encoded data stream, including the steps of reading a predetermined amount of encoded data from the data stream and identifying an entry of a decode data table using the predetermined amount of read data and a current state value. The decode data table has a plurality of table entries, each including a state field containing state information and a data field containing a predetermined data pattern. The identified table entry is read and the state information and the predetermined data pattern are extracted from it. Next, the predetermined data pattern is output as decoded data.

In accordance with the second embodiment of the invention, a data structure for decoding predetermined amounts of HDLC protocol compliant data read from a data stream is provided. The data structure includes a data field containing HDLC decoded data corresponding to the predetermined amount of encoded data read from the data stream, a state field corresponding to a current count of consecutive bits having a value of one read from the data stream, an A flag field for indicating an HDLC abort sequence, a F flag field for indicating an HDLC flag sequence, and a D-bit field that indicates a number of the bits in the data field that comprise valid data.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a flow chart of a method of encoding and decoding data conforming to a predetermined protocol in accordance with the present invention;

FIG. 2 is an example of a format of a table entry for a data encoding process in accordance with the present invention;

FIG. 3 is an example of a format of a table entry for a data decoding process in accordance with the present invention;

FIG. 4 is table illustrating an example of the data encoding process of the present invention;

FIG. 5 is a table illustrating an example of the data decoding process of the present invention;

FIG. 6 is a portion of a data encoding look up table in accordance with the present invention; and

FIG. 7 is a portion of a data decoding look up table in accordance with the present invention.

### DETAILED DESCRIPTION OF PREFERRED EMBODIMENTS

In the drawings, like numerals are used to indicate like elements throughout.

The present invention provides methods to encode and decode frames of data used in synchronous protocols like HDLC and SDLC and is useful for ISDN stack operations, ISDN transceiver equipment and other applications requiring asynchronous to synchronous conversion, rate adaptation, and the like. As explained in detail below with reference to the HDLC protocol, the invention performs the flag or abort signal detection, consecutive one bits detection, zero detection, zero deletion and zero insertion processes on a data byte or word basis, using reference or “lookup” tables.

The invention operates on blocks of data, in a parallel rather than a bit serial manner. A block of data or a block may refer to any grouping of digital information comprising more than one bit, such as an eight bit byte, a sixteen bit word, a thirty-two bit word, or other lengths of data. While the preferred embodiment of the invention performs encoding and decoding upon data bytes, it should be understood that the methods disclosed herein may be generalized and modified by those skilled in the art to operate on larger or smaller blocks of data.

The present invention has been implemented using a Motorola M5206E microprocessor and on a Motorola DSP56303 digital signal processor, both of which are commercially available. As disclosed herein, the present invention has provided approximately a four-fold increase in the speed of decoding and encoding data over previous HDLC protocol methods. Although the preferred embodiment of the invention is implemented in software, it will be understood by those of ordinary skill in the art that the invention can also be implemented in hardware, for instance, using hardwired lookup tables and a hardware state machine.

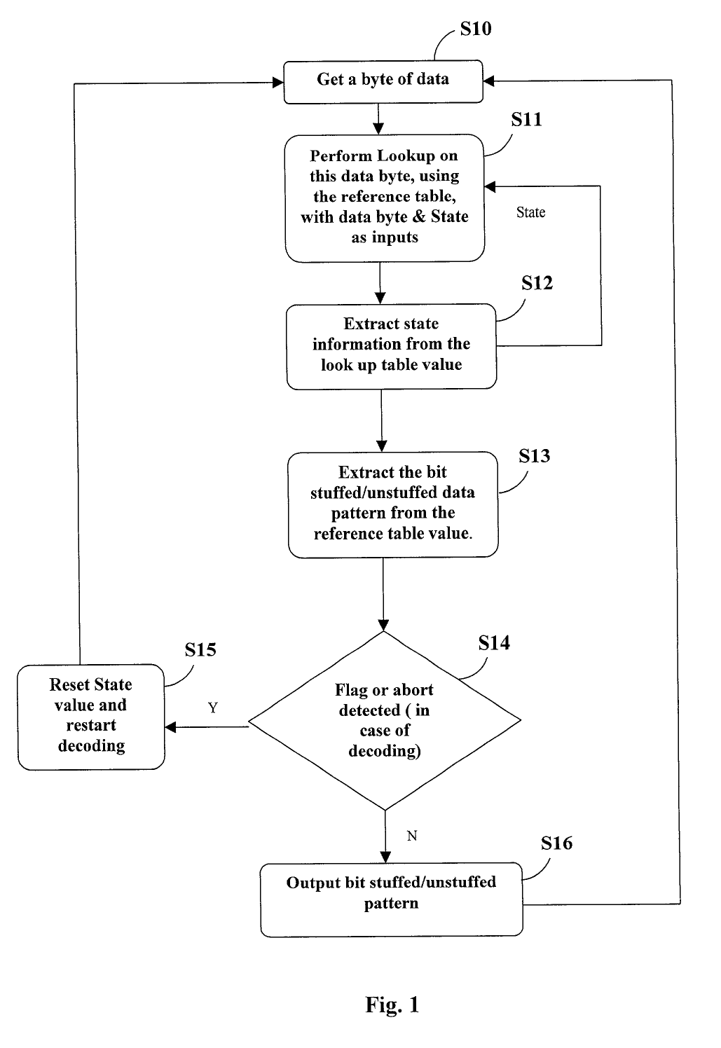

Referring to FIG. 1, a flow chart of methods for encoding and decoding a data stream are shown. The encoding and decoding processes will now be described in terms of encoding a raw bit stream is converted to HDLC frames and decoding HDLC encoded frames of data.

First, at step S10, a predetermined amount of data, in this case an eight-bit byte, is read (for the encode process) or received (for the decode process) from the data stream. In the encoding process, the bit stream comprises uncoded or raw data and for the decoding process, the bit stream comprises coded data. At step S11, the read/received byte of data and a current state value are used as an index into a look up table. For the encode process, an encode data table is provided and for the decode process, a decode data table is provided. Initially, for the first byte of data, the current state value is zero. Thereafter, the current state value is the state value obtained from the last read table entry.

On the encode side, the data byte and the state value are used as an index to the reference table and the corresponding table entry contains the zero inserted sequence for that particular byte, the number of consecutive ones in that particular byte and the total number of zeros inserted.

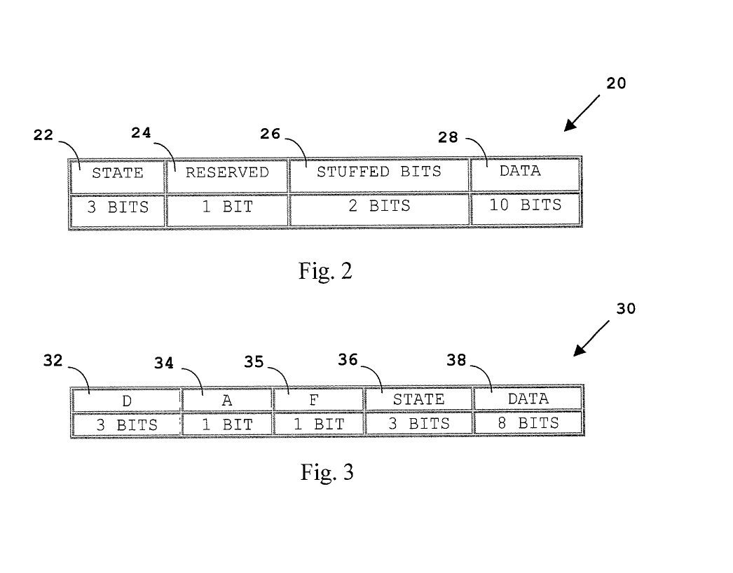

Referring now to FIG. 2, the format of an encode data table entry 20 is shown. Preferably, each encode data table entry 20 includes a three bit state field 22, a one bit reserved field 24, a two bit stuffed bits field 26 and a ten bit data field 28. Briefly, the state field 22 contains a current count of the number of consecutive bits having a value of one read from the data stream. As discussed in more detail below, the state value is used to identify the next table entry to be read. The reserved bit 24 is presently not used. The stuffed bits field 26 identifies the number of bits (0s) added to the read data to form the data field 28, and the data field 28 contains the HDLC encoded data that corresponds to the byte of data read from the data stream. The data field 28 is ten-bits in order to account for 8 bits of data plus two added or stuffed bits.

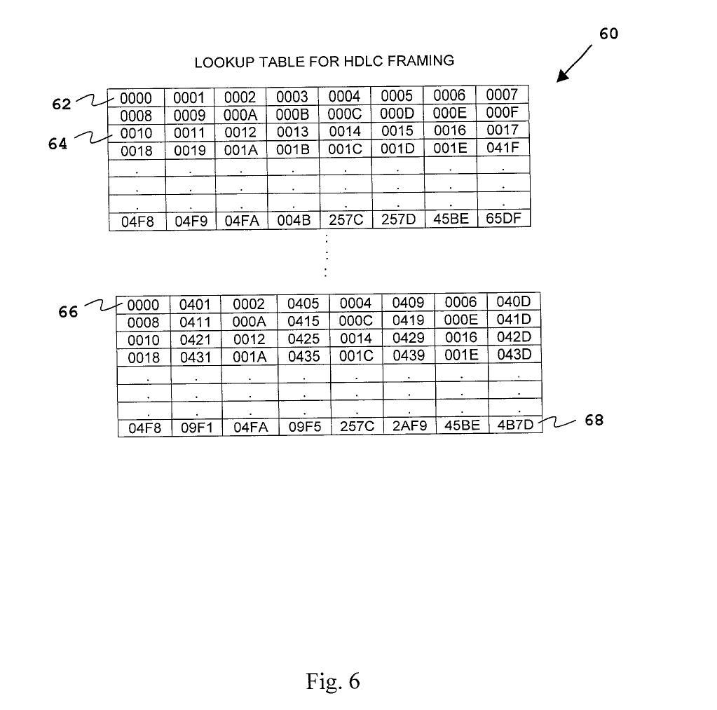

The encode data table is structured in such a way that it caters to five possible states. Thus, in the presently preferred embodiment, since the encode lookup table is accessed using one byte of data (8 bits) and one of five state values, the encode data table has 2**8 * 5 or 1280 entries. FIG. 6 shows a portion of an encode data table 60. In the table 60, the first entry 62 is accessed with a data byte of ‘0000 0000’ and a state value of ‘000’. The table entry 64 is accessed with a data byte of ‘0000 0010’ and a state value of ‘000’. The table entry 66 is accessed with a data byte of ‘0000 0000’ and a state value of ‘101’. The table entry 68 is accessed with a data byte of ‘1111 1111’ and a state value of ‘101’.

Reading the value of the table entry 68, ‘4B7D’ or ‘0100 1011 0111 1101’, the state field 22 contains a value of ‘010’, which value will be used as the current state value for accessing the next encode table entry for the next byte of read data. The stuffed bits field 26 is ‘10’, which indicates that two ‘0’ bits have been stuffed in the data field 28. The ten-bit data field 28 for this entry 68 is ‘1101111101’.

On the decode side, the received data byte is used as an index to the decode data table and the table entry contains the corresponding zero deleted sequence, flag or abort sequence detection bits if the input happens to be a flag or abort sequence, number of consecutive ones in the input byte and the number of valid data bits.

FIG. 3 illustrates the format of a decode data table entry 30. Preferably, each decode data table entry 30 includes a three bit D-bit field 32, a one bit A flag field 34, a one bit F flag field 35, a three bit state field 36, and an eight bit data field 38. The A flag field 34, when set, indicates detection of an HDLC abort sequence (0111 1111) and the F flag field 35, when set, indicates detection of an HDLC flag sequence (0111 1110). The state field 36, like the state field 22, contains a current count of the number of consecutive bits having a value of one read from the encoded data stream and is used to access the table entry for the next block of read data. The data field 38 contains HDLC decoded data that corresponds to the encoded data read from the data stream. Finally, the D-bit field 32 identifies the number of valid data bits in the data field 38. More particularly, if the F flag and the A flag are both zero, then the number of valid data bits in the data field 38 is the value of the D-bit field 32 plus one. The usage of the D-bit field, as well as the importance and usage of each of the tables and their corresponding entries are discussed in more detail below and will become apparent via examples of the encoding and decoding processes.

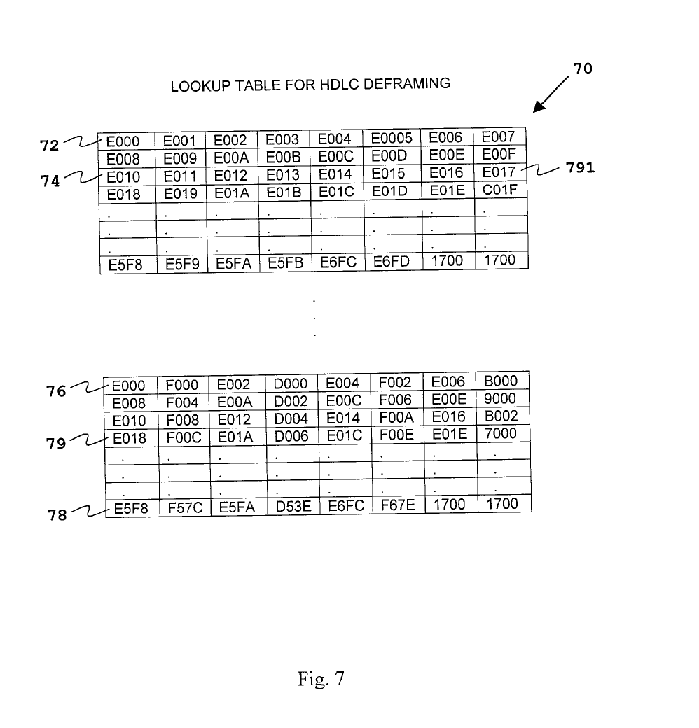

FIG. 7 shows a portion of an decode data table 70. The decode data table 70 is structured in such a way that it caters to eight possible decode states. Thus, in the presently preferred embodiment, since the decode data table 70 is accessed using one byte of data (8 bits) and one of eight state values, the encode data table has 2**8 * 8 or 2048 entries. In the table 70, the first entry 72 is accessed with a data byte of ‘0000 0000’ and a state value of ‘000’. The table entry 74 is accessed with a data byte of ‘0000 0010’ and a state value of ‘000’. The table entry 76 is accessed with a data byte of ‘0000 0000’ and a state value of ‘111’. The table entry 78 is accessed with a data byte of ‘1111 1000’ and a state value of ‘111’.

Reading the value of the table entry 78, ‘E5F8’ or ‘1110 0101 1111 1000’, the D-bits field 32 contains a value of ‘111’, the A bit field 34 and the F bit field 35 are both clear indicating that neither an Abort sequence nor a Flag has been detected and the state field 36 is ‘101’, which value will be used as the current state value for accessing the next encode table entry for the next byte of received data. The eight bit data field 38 for this entry 78 is ‘1111 1000’. Using the D-bit field 32, since F and A are ‘0’, the number of valid data bits in the data field 38 is ‘111’+1, which is 8. Thus, for this entry 78 all of the bits in the data field 38 are valid, decoded data, and would be output as such.

Referring again to FIG. 1, at step S12, after a table entry has been accessed, the state information is extracted from the entry for use in accessing the next table entry. At step S13, the data pattern is extracted from the read table entry. That is, for the encode process, the bit stuffed pattern is extracted from the data field 28 and for the decode process, the bit unstuffed data pattern is extracted from the data field 38.

At step S14, for the decode process, the flag fields 34, 35 are read and checked to determine if either of the F flag bit of the A flag bit is set, which would indicate receipt of a flag sequence or an abort sequence, respectively. If either the flag sequence or the abort sequence is detected, then step S15 is performed, in which case the current state value is reset to zero and the decoding process is restarted. Alternatively, step S16 is performed, in which case the bit pattern read from the table entry is output as either encoded or decoded data.

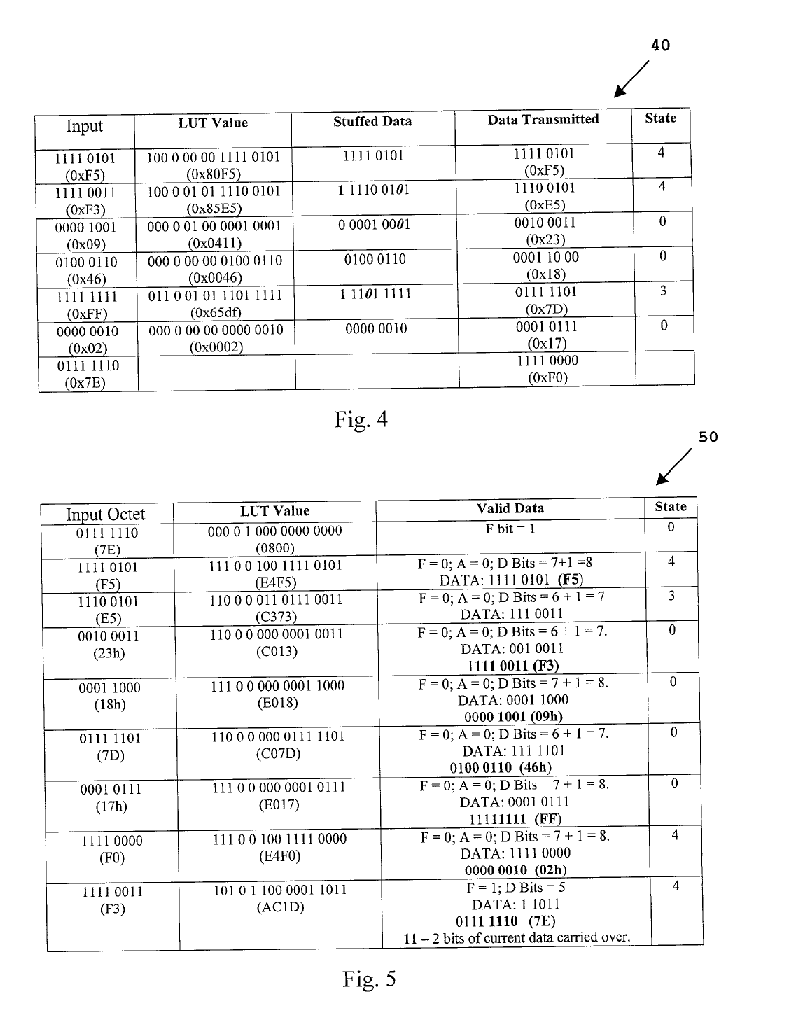

Referring now to FIG. 4, a table 40 for explaining an example of an HDLC encoding operation is shown. The input sequence is shown in column 1 of the table 40. Column 2 of the table 40 shows the value of the encode data table entry identified by the input data and current state value. Column 3 of the table 40 shows the data and any stuffed bits, column 4 shows the encoded data output and column 5 shows the current state value. In the example, an input sequence of F5, F3, 09, 46, FF, 02 is encoded using the encode data table 60 having entries in the format shown in FIG. 2. As previously discussed, the encode data table 60 is preferably a two-dimensional array accessed using the input data and a state value. The input data is read from LSB to MSB (bit 7 to bit 0). The initial state value is zero.

At row 1, the first byte of the bit stream is read and has a value of F5 or ‘1111 0101’. Accordingly, the value at the encode data table entry identified by F5, 0 is accessed. Column 2 of the table 40 shows the identified encode data table entry, which in this case is 80F5 or ‘1000 0000 1111 0101’, which further breaks down to state=‘100’, stuffed bits=‘00’ and data=‘1111 0101’. The data output, F5, is eight bits, as opposed to nine or ten bits because the number of stuffed bits is zero.

The second block of input data is F3 or ‘1111 0011’, as shown at row 2, column 1. Using the input data and the state value of 4 read from the previous table entry, a new table entry is accessed. The new table entry has the value 85E5 or ‘1000 0101 1110 0101’, as indicated at row 2, column 2, which breaks down to state=‘100’, stuffed bits=‘01’ and data=‘1 1110 0101’. Note that one zero is stuffed, as indicated at row 2, col. 3. Since one bit is stuffed, the data field has nine data bits. However, as shown at row 2, col. 4, the next eight bits output are E5 and the one highlighted bit (‘1’) will be carried over and output with the next octet.

At row 3, the next input block is read, ‘0000 1001’. The table entry indicated by the input data and current state value (09h/4) is ‘0000 0100 0001 0001’, as indicated at row 3, column 2, which breaks down to state=‘000’, stuffed bits=‘01’ and data=‘00 0001 0001’. Again, since a string of 5 ones has been encountered (i.e., the last 4 bits of the previous input ‘F’ and the first bit of this input ‘1’), one zero bit is stuffed, as indicated at row 3, col. 3. Since one bit is stuffed, the number of valid bits in the data field will be nine. However, as shown at row 3, col. 4, because of the 1 bit carried over from the previous row, the next eight bits output are 23h. That is, ‘0 0001 0001’ with ‘1’ aligned to eight bits is ‘0010 0011’ with two bits ‘00’ that will be carried over to the next octet output.

Moving now to row 4, the next input block is 46h or ‘0100 0110’. The table entry indicated by the input data and current state value (46h/0) is ‘0000 0000 0100 0110’, as indicated at row 4, column 2, which breaks down to state=‘000’, stuffed bits=‘00’ and data=‘00 0100 0110’. Since no bits are stuffed, the number of valid bits in the data field will be eight. However, as shown at row 4, col. 4, because of the 2 bits carried over from the previous row (‘00’), the next bits to be output are ‘0100 0110 00’, which is aligned as ‘0001 1000’ or 18h. Again, two bits will be carried over to the next output octet, this time ‘01’.

The next input block read is ‘FF’ indicated at row 5 and the table entry accessed by ‘FF’/‘0’ is ‘65DF’ or ‘0110 0101 1101 1111’, which breaks down to state=‘011’, stuffed bits=‘01’ and data=‘01 1101 1111’. Here, one bit is stuffed, as indicated in italics at row 5, column 3, so the number of valid data bits in the data field changes from 8 to 9. However, as shown at row 5, col. 4, because of the 2 bits carried over from the previous row (‘01’), the next bits to be output are ‘11101 1111 01’, which aligned as an octet is ‘0111 1101’or 7D. Now, instead of just two bits being carried over to the next output octet, this time three bits are carried over ‘111’.

Finally, row 6 shows the last input block, which is 02h. The table entry indicated by the input data and current state value (02h/3) is ‘0000 0000 0000 0010’, as indicated at row 6, column 2, which breaks down to state=‘000’, stuffed bits=‘00’and data=‘00 0000 0010’. Since no bits are stuffed, the number of valid bits in the data field is eight. However, three bits are carried over from the previous row (‘111’), so the next bits output are ‘0000 0010 111’, which is aligned as ‘00 0001 0111’ or 17h. Again, three bits will be carried over to the next output octet, this time ‘000’.

Since there is no more data to be read, the three bits carried over will be output followed by a closing flag 7E. Thus, ‘0111 1110 000’ provides a next output octet of F0 and three bits ‘011’ carried over to the final output octet. Therefore, for the input stream of F5,F3,09,46,FF,02, the encoded output stream is F5,E5,23,18,7D,17,F0,F3.

Referring now to FIG. 5, a table 50 illustrating an example of the HDLC decoding process is shown. The input sequence is shown in column 1 of the table 40 as 7E,F5,E5,23,18,7D,17,F0,F3.Note that the input sequence is the same as the output sequence of the encoding example previously discussed, preceded by the flag sequence 7E. Column 2 of the table 50 shows the value of the decode data table entry identified by the input data and current state value. Column 3 of the table 50 shows the decoded data value, a calculation of the valid data bits, and the flag field values. In column 3, the data bits output that are carried over from the previous table entry are highlighted. Column 5 shows the current state value. In the example, the input sequence is decoded using the decode data table 70 having entries in the format shown in FIG. 3. As previously discussed, the decode data table 70 is preferably a two-dimensional array accessed using the input data and a state value. The input data is read from LSB to MSB (bit 7 to bit 0). The initial state value is zero.

As shown at row 1, col. 1, the first input octet is 7Eh and, using the initial state value of zero, the corresponding decode table entry is 0800h or ‘0000 1000 0000 0000’, which breaks down to D-bits=‘000’, A flag is clear and F flag is set, state=‘000’ and data=‘0000 0000’. Since the F flag is set, the first input block is the flag sequence (7E).

The next block of data read is F5, so the decode table entry at F5/0 is read, which contains a value of ‘1110 0100 1111 0101’, which breaks down as D-bits=‘111’, A flag and F flag are clear, state=‘100’ and data=‘1111 0101’. The number of valid data bits is calculated as D-bits+1, which in this case is 7+1=8. Therefore, all 8 bits are valid data and so the first decoded data block output is F5.

Next, E5 is input and the table entry at E5/4 is read, which is ‘1100 0011 0111 0011’, providing D-bits=‘110’, A flag and F flag are clear, state=‘011’ and data=‘0111 0011’. The number of valid data bits is 6+1=7. Therefore, the valid data bits are ‘111 0011’. Since the previous output was an octet, and now only 7 bits are valid, all 7 bits are carried over. That is, the 7 bits are held in a buffer until there are at least 8 bits of data to output.

Next, as shown at row 4, 23h is input and the table entry at 23/3 is read, which is ‘1100 0000 0001 0011’, providing D-bits=‘110’, A flag and F flag are clear, state=‘000’ and data=‘0001 0011’. The number of valid data bits is 6+1=7. Therefore, the valid data bits are ‘001 0011’ plus the previous 7 bits carried over (‘111 0011’). Thus, 8 bits are output and 6 bits (14-8) are held in the buffer. The 8 bits output are ‘1 111 0011’ (F3) and the 6 bits to be carried over are ‘001 001’.

At row 5, col. 1, the next block of encoded data received is 18h and the decode table entry at 18/0 is ‘1110 0000 0001 1000’. Note this matches the entry 79 of the table 70 (FIG. 7). The individual field values are D-bits=‘111’, A flag and F flag are clear, state=‘000’ and data=‘0001 1000’. The number of valid data bits is 7+1=8. Therefore, the valid data bits are ‘0001 1000’ plus the previous 6 bits carried over (‘001 001’). Thus, 8 bits are output and 6 bits (14-8) are once again held in the buffer or carried over. The 8 bits output are ‘00 001 001’ (09h) and the 6 bits to be carried over are ‘000110’.

At row 6, col. 1, the next block of encoded data received is 7D and the decode table entry at 7D/0 is ‘1100 0000 0111 1101’. The individual field values are D-bits=‘110’, A flag and F flag are clear, state=‘000’ and data=‘0111 1101’. The number of valid data bits is 6+1=7. Therefore, the valid data bits are ‘111 1101’ plus the previous 6 bits carried over (‘000110’). Thus, the 8 bits output are ‘01’ and ‘000110’ or 46h and the remaining 5 bits (7 valid+6 carried over−8 output=5) are now carried over (‘11111’).

At row 7, col. 1, the next block of encoded data received is 17h and the decode table entry at 17/0 is ‘1110 0000 0001 0111’ (E017), which matches the table entry 791 of the table 70 (FIG. 7). The individual field values are D-bits=‘111’, A flag and F flag are clear, state=‘000’ and data=‘0001 0111’. The number of valid data bits is thus 7+1=8. Therefore, the valid data bits are ‘0001 0111’ plus the previous 5 bits carried over (‘11111’). Thus, the 8 bits output are ‘111’ and ‘11111’ or FF and the remaining 5 bits (8 valid+5 carried over−8 output=5) are now carried over (‘00010’).

At row 8, col. 1, the next block of encoded data received is F0 and the decode table entry at F0/0 is ‘1110 0100 1111 0000’. The individual field values are D-bits=‘111’, A flag and F flag are clear, state=‘100’ and data=‘1111 0000’. The number of valid data bits is 7+1=8. Therefore, the valid data bits are ‘1111 0000’ plus the previous 5 bits carried over (‘00010’). Thus, the 8 bits output are ‘000’ and ‘00010’ or 02h and the remaining 5 bits (8 valid+5 carried over−8 output =5) carried over are (‘11110’).

At row 9, col. 1, the final block of encoded data received is F3 and the decode table entry at F3/4 is ‘1010 1100 0001 1011’. The individual field values are D-bits=‘101’, A flag is clear and F flag is set, state=‘100’ and data=‘0001 1011’. Since the F flag is set, a flag sequence has been detected, indicating the end of the encoded data. The number of valid data bits is 5 (since F flag is set, D-bits=D-bits). Therefore, the valid data bits are ‘1 1011’ plus the previous 5 bits carried over (‘11110’). Thus, the 8 bits output are ‘011’ and ‘11110’ or 7E and there are two bits remaining (5 valid+5 carried over−8 output=2), which are ‘11’.

In accordance with the decode example, the decoded output stream is thus F5,F3,09h,46h,FF,02h.

As is apparent from the above, the present invention provides method of encoding and decoding blocks of data using reference tables. Since the decode and encode processes each use a single look up table, only a single read operation is required to perform either a decode operation or an encode operation on a block of data. Thus, the block of data is processed very quickly.

As seen from the example, the present invention also checks for data under run and overrun conditions. When acting as a receiver and decoder, if a data under run has occurred, the process is aborted and resumes upon receipt or shifting of another byte or word. Correspondingly, when acting as an encoder and transmitter, the process checks for a data overrun and continues encoding and transmitting until the data is exhausted.

It will be appreciated by those skilled in the art that changes could be made to the embodiments described above without departing from the broad inventive concept thereof. For example, although the present invention has been described with reference to HDLC encoding and decoding, the invention can be adapted and applied to other protocols, such as SDLC. It is understood, therefore, that this invention is not limited to the particular embodiments disclosed, but it is intended to cover modifications within the spirit and scope of the present invention as defined by the appended claims.

1. A method of encoding a data stream, comprising:
reading a predetermined amount of data from the data stream;
identifying an entry of an encode data table using the predetermined amount of read data and a current state value, the encode data table having a plurality of table entries, each table entry including a state field containing state information and a data field containing a predetermined data pattern;
reading the identified table entry;
extracting the state information from the read table entry;
extracting the predetermined data pattern from the read table entry; and
outputting the predetermined data pattern as encoded data.

2. The method of claim 1, wherein the predetermined amount of data read from the data stream is one byte.

3. The method of claim 1, wherein the predetermined amount of data read from the data stream is one word.

4. The method of claim 1, wherein the current state value is initially zero.

5. The method of claim 4, wherein the current state value, after the initial current state value, is defined by the state information extracted from the most recently read table entry.

6. The method of claim 1, wherein the outputted encoded data complies with the HDLC protocol.

7. The method of claim 6, wherein the state field indicates a current count of consecutive bits having a value of one read from the data stream.

8. The method of claim 7, wherein each table entry further includes a stuffed bits field that identifies a number of bits added to the predetermined amount of read data to form the predetermined data pattern.

9. The method of claim 8, wherein the state field comprises three bits, the data field comprises ten bits and the stuffed bits field comprises two bits.

10. The method of claim 1, wherein the outputted encoded data complies with the SDLC protocol.

11. A data structure for encoding predetermined amounts of data read from a data stream to HDLC protocol compliant data, comprising:
a data field containing HDLC encoded data corresponding to the predetermined amount of data read from the data stream;
a state field defined by a current count of consecutive bits having a value of one read from the data stream; and
a stuffed bits field defined by a number of bits added to the predetermined amount of data to form the HDLC encoded data in the data field.

12. The data structure of claim 11, wherein the data field is ten bits, the state field is three bits and the stuffed bits field is two bits.

13. A method of decoding an encoded data stream, comprising:
reading a predetermined amount of encoded data from the data stream;
identifying an entry of a decode data table using the predetermined amount of read data and a current state value, the decode data table having a plurality of table entries, each table entry including a state field containing state information and a data field containing a predetermined data pattern;
reading the identified table entry;
extracting the state information from the read table entry;
extracting the predetermined data pattern from the read table entry; and
outputting the predetermined data pattern as decoded data.

14. The method of claim 13, wherein the predetermined amount of data read from the data stream is one byte.

15. The method of claim 13, wherein the current state value is initially zero.

16. The method of claim 15, wherein the current state value, after the initial current state value, is defined by the state information extracted from the most recently read table entry.

17. The method of claim 13, wherein the encoded data stream comprises HDLC protocol encoded data.

18. The method of claim 17, wherein each table entry further includes an A flag bit for indicating an HDLC abort sequence and a F flag bit for indicating an HDLC flag sequence.

19. The method of claim 18, wherein each table entry further includes a D-bit field that identifies a number of valid data bits in the data field.

20. The method of claim 19, wherein the state field comprises three bits, the data field comprises eight bits and the D-bit field comprises three bits.

21. A data structure for decoding predetermined amounts of HDLC protocol complaint data read from a data stream, comprising:
a data field containing HDLC decoded data corresponding to the predetermined amount of encoded data read from the data stream;
a state field corresponding to a current count of consecutive bits having a value of one read from the data stream;
an A flag field for indicating an HDLC abort sequence;
a F flag field for indicating an HDLC flag sequence; and
a D-bit field that indicates a number of the bits in the data field that comprise valid data.

22. The method of claim 21, wherein the state field is three bits, the data field is eight bits, the A flag field and the F flag field are each one bit, and the D-bit field is three bits.
